(19) United States
(12) Patent Application Publication
(10) Pub. No.: US 2006/0101717 A1
(43) Pub. Date: May 18, 2006

(54) Formed arch

(76) Inventor: Mario Marocco, Woodbridge (CA)

Correspondence Address: MILLER THOMPSON, LLP, Scotia Plaza, 40 King Street West, Suite 5800, TORONTO, ON, M5H 3S1, CA

(21) Appl. No.: 10/986,014

(22) Filed: Nov. 12, 2004

(51) Int. Cl. E06B 7/08

(52) U.S. Cl. 49/74.1

(57) ABSTRACT

A venetian blind style of window shutter is provided which may be used in a window opening comprising an arch, a device for measuring an arched window opening for manufacture of a shutter, and a method of manufacture of a shutter for an arched window. The shutter has high strength and precision, offers uniform appearance and consistent light control, and can be manufactured without requiring expensive machinery, extensive labour or highly skilled tradespersons.

### TECHNICAL FIELD OF THE INVENTION

The present invention relates to window shutters. In particular, the present invention relates to a venetian blind style of window shutter which m ay be used in a window opening comprising an arch. In another embodiment the invention relates to a palladian blind style of window shutter.

### BACKGROUND OF THE INVENTION

It is known to provide a window covering for an arched window. Examples of such window coverings include those described in U.S. Pat. No. 5,794,680 entitled “Retractable Arced Window Covering” to Xue (“Xue”) and U.S. Pat. No. 5,584,329 entitled “Movable shade for Palladian Windows” to Thomas (“Thomas”).

Xue teaches a pleated fan covering for an arched window which can be drawn across the window by pulling a cord attached to one side of the pleated fan. Thomas describes two sets of linked blades which can be separately drawn across either the left side or the right side of an arched window.

It is also known to provide a shutter for an arched window in which louvers are arrayed radially about an arched window. Examples of such radially arranged shutters include those described in U.S. Pat. No. 5,537,780 entitled “Louver Mechanism for Palladian Windows” to Cleaver et al (“Cleaver”) and U.S. Pat. No. 6,341,447 entitled “Half Circle Window Shutter/Blind” to Jean (“Jean”).

Jean teaches a radially arrayed louver system in which each louver may be manually rotated individually into a desired position. The invention in Cleaver comprises a radially arrayed louver system in which the louvers are turned in unison by a motor-driven gear mechanism.

It is further known to provide a louvered shutter for an arched window in which the louvers are arranged horizontally. U.S. Pat. No. 6,062,291 entitled “Venetian Blind for Palladian-Style Window to Morgan et al (“Morgan”) teaches a window shutter in which horizontal louvers are suspended by a plurality of ladder cords which are connected to a gear mechanism to permit rotation of the suspended louvers.

There are a number of desirable objectives in relation to shutters for arched windows. Such shutters should preferably comprise horizontal louvers to optimize control of light entry through the window. The shutter assembly should be mechanically simple for ease of manufacture and operation. The shutter opening means should preferably be integrated into the shutter design for aesthetic and safety reasons.

Existing arched window coverings achieve some of these objectives, but with varying degrees of success. For example, Xue and Thomas describe window coverings which do not permit incremental control of light for each area of the window. Rather, the fan-style covering may only be open or closed over a particular portion of the window.

Jean and Cleaver permit greater control over light entry through use of radially arrayed louvers. However, such radially arrayed louvers would not permit an even entry of light through the window. Rather, for a particular sun position, distinct portions of the shutter will block the light to varying degrees across the arched window. In addition, as the sun passes generally horizontally across the sky, the shutters of Jean and Cleaver would need to be frequently adjusted to maintain consistent light levels.

Morgan teaches a shutter for an arched window having horizontally arranged louvers. However, the system for rotating the louvers to permit or exclude light is relatively complex, involving rollers, ladder cords and gears. Such complexity increases the cost and difficulty of manufacturing of the shutters, and increases the likelihood of mechanical failure.

It is an object of the present invention to provide, for an arched window, a shutter which provides rotatable horizontal louvers which allow consistent, controllable light entry across the entire window area. It is a further object of the present invention to provide such a shutter which is mechanically simple for ease of manufacture and repair.

### SUMMARY OF THE INVENTION

One aspect of the invention relates to a shutter for an arch window having at least one rotatable louver.

According to another aspect of the present invention, there is provided a shutter for an arched window, comprising a base member, a curved member secured to the base member, at least one louver having an axis of rotation, at least one pair of louver receiving means disposed about the curved member for releasably attaching the louver to the curved member, and means for rotating the louver about the axis of rotation between an open position and a closed position.

The shutter may comprise a plurality of louvers each having an axis of rotation, disposed generally parallel to one another. The louvers and the louver receiving means may have substantially the same cross-section.

In one embodiment, there is provided a shutter for an arched window comprising a curved member having horizontally opposed ends, a horizontal member extending between the opposed ends of the curved member, one or more pairs of louver receiving means for releasably attaching louvers to the curved member, each element of each pair fixedly attached at horizontally opposed positions to the curved member, one or more louvers having opposed ends and opposed first and second lateral edges, each end of each louver releasably attached by rotating means only to a corresponding element of a corresponding pair of louver receiving means, and light control means for rotating the one or more louvers, fixedly attached at vertically adjacent positions to the first lateral edge of each louver, wherein the light control means are vertically displaceable to a selected position between an open position and a closed position.

The shutter may comprise at least one stile extending vertically between the base member and the curved member, the stile fixedly attached to an adjacent edge of each louver.

The curved member may have a generally U-shaped cross section, flat section, hollow tubular or rectangular section, or other suitable sections.

The shutter may further comprise a valance releasably attachable to the curved member and base member, which may be formed by a roll-forming machine, which may be computerized. The shutter may be formed of aluminum, wood or PVC.

The rotating means may comprise a spring-loaded pin.

A further aspect of this invention relates to a shutter for an arched window comprising a base member, a curved member secured to said base member, said curved member having a hollow cross-section, a plurality of radially overlapping louvers having one end connected to said curved member and said other end connected to said base member, said louver each rotated about a radial axis of rotation.

Still yet another aspect of this invention relates to a method of manufacturing a shutter for an arched window comprising the steps of forming a curved member, attaching a base member to opposite ends of said curved member, placing a plurality of overlapping louvers on said member, cutting each said louver to the shape of said arched window, and to form a louver and louver receiving means attached to said curved member, attaching each said pair of louver receiving means to said curved member.

In another of its aspects, the present invention provides a method of manufacturing a shutter for an arched window comprising the steps of preparing a template of the shape of the blind, forming a curved member which geometrically corresponds to the template, attaching a base member to opposed ends of the curved member, cutting one or more source members to a length which corresponds to the horizontal width of the curved member at the installation position corresponding for each louver, cutting each end of each source member to geometrically correspond to the curved member at the installation position for each louver, cutting a straight edge through each source member at a position proximal to each end to form a louver and a pair of corresponding louver receiving means, preparing and painting each straight edge of each louver and each pair of louver receiving means, drilling a hole in each louver and for attachment of a light control means pin, drilling a hole in the straight edge of each louver and each louver receiving means for attachment of louver pins, fastening each pair of louver receiving means to horizontally opposite corresponding positions on the curved member, fastening each louver to a corresponding pair of louver receiving means and to the light control means, cutting a flexible valance to a length corresponding to the combined length of the curved member and base member, and attaching the valance to the exposed face of curved member and base member.

The method of manufacturing the shutter may further comprise the steps of, after attaching the base member to the curved member, attaching one or more vertical stiles between adjacent vertical positions of the base member and the curved member, drilling a hole in adjacent positions on one lateral edge of each louver for attaching the one or more vertical stiles to each louver and a series of corresponding holes on the one or more stiles, and fastening each louver to the one or more stiles.

The step of preparing a template of the shape of the blind may comprise the steps of measuring and recording on recording media with measuring means the linear distance from the horizontal mid-point of the base of the arched window to one end of the base of the arched window, measuring and recording on recording media the linear distance from the horizontal mid-point of the base of the arched window to a point incrementally along the arc of the arched window and the angle of the radius at that point relative to the base of the window, and repeating the previous step until the entire arched window has been measured and recorded on recording media.

The recording media may comprise a markable grid, or an electronic recording medium.

The measuring means may comprise a measuring device having telescoping arms which selectively transmits the linear distance between the distal ends of the telescoping arms to an electronic recording medium.

The step of forming a curved member which corresponds to the template may comprise the steps of cutting a length of linear rail corresponding in length to the perimeter of the arc of the arched window, and passing the linear rail through roller forming means, the roller forming means comprising three rollers, each adjustable by adjustment means for shaping the rail into a curved member corresponding to the template.

The adjustment means may comprise manual adjustment means, or a computerized system interfaced with the template.

According to a further aspect of the invention, there is provided a measuring device for measuring the arc of an arched window, comprising a leveling mechanism, a pivot arm having first and second opposed ends, a measuring arm swingable at a first end to the first end of the pivot arm, measuring means for determining the linear distance between the second ends of the arms, and recording means for selectively recording the distance between the distal ends of the arms.

A further aspect of this invention relates to a finished surface for an aluminum extrusion formed in a curve for receiving retractable shutters, said finished surface removably securable to said aluminum extrusion.

Other aspects of the invention will be appreciated by reference to the description of the preferred embodiment which follows, and to the claims.

### BRIEF DESCRIPTION OF THE DRAWINGS

The invention will be described by reference to the preferred embodiment and the drawings thereof in which:

FIG. 1 is a front perspective view of the shutter without stile according to the invention, with louvers in a closed position;

FIG. 1A is a sectional view along lines 1a-1a of FIG. 1.

FIG. 2 is a front perspective view of the shutter with stile according to the invention, with louvers in an open position;

FIG. 3 is a transverse cross-sectional view of the curved member;

FIG. 4 is a front view of two positions of a fixed linear measuring device according to the invention;

FIG. 5 is measuring template according to the invention depicting the geometry of a portion of an arched window;

FIG. 6 is a front view of three positions of a spring-loaded measuring device according to the invention;

FIG. 7 is a front view of an eye-lid shaped window;

FIG. 8 is a linear cross-section of the curved member being formed between the three rollers of a computerized roll-forming machine, according to the invention;

FIG. 9 is a transverse cross-section of the curved member and one roller of the CNC machine, according to the invention;

FIG. 10 is a front view of an assembly of a base member, a curved member and a stile;

FIG. 11 is a front view of an assembly of a base member, a curved member, a stile and several right-side louver source members;

FIG. 12 is a view of a louver source member depicting the curved portion to be removed;

FIG. 13 is a louver and louver receiving means depicting the positions of the louver pin holes and the pull bar pin hole;

FIG. 14 is a right side front view of a curved member, a base member, a stile and a plurality of installed louver receiving means;

FIG. 15 is a perspective view of two louvers positioned for attachment to a stile;

FIG. 16 is a right side front view of a curved member, a base member, a stile, a plurality of louvers and louver receiving means, and a pull bar;

FIG. 17 is a front view of the shutter according to the invention showing partial attachment of the valance; and

FIG. 18 is a front view of the fully assembled shutter according to the invention.

FIG. 19A is a perspective view of another embodiment of a curved member selected from a flat stock prior to being bent into a curve.

FIG. 19B is a view showing the flat stock after being curved.

FIG. 19C is a top plan view showing the view of the curved flat member.

FIG. 19D is a cross-sectional view along the lines of FIG. 19d-19d of FIG. 19C.

FIG. 20 is another embodiment of the invention.

FIG. 21 is a cross-sectional view along the lines 21-21 of FIG. 20.

FIG. 22 shows another embodiment of the invention having a circular shutter.

FIG. 23 shows another embodiment of the invention having a formed arch merging with straight parallel edges.

FIG. 24 is a cross-sectional view along the lines 24 in FIG. 23.

FIG. 25 illustrates another embodiment of the coping.

FIG. 26 illustrates a one piece presenting louver receiving means.

### DETAILED DESCRIPTION OF BEST MODE AND PREFERRED EMBODIMENT OF THE INVENTION

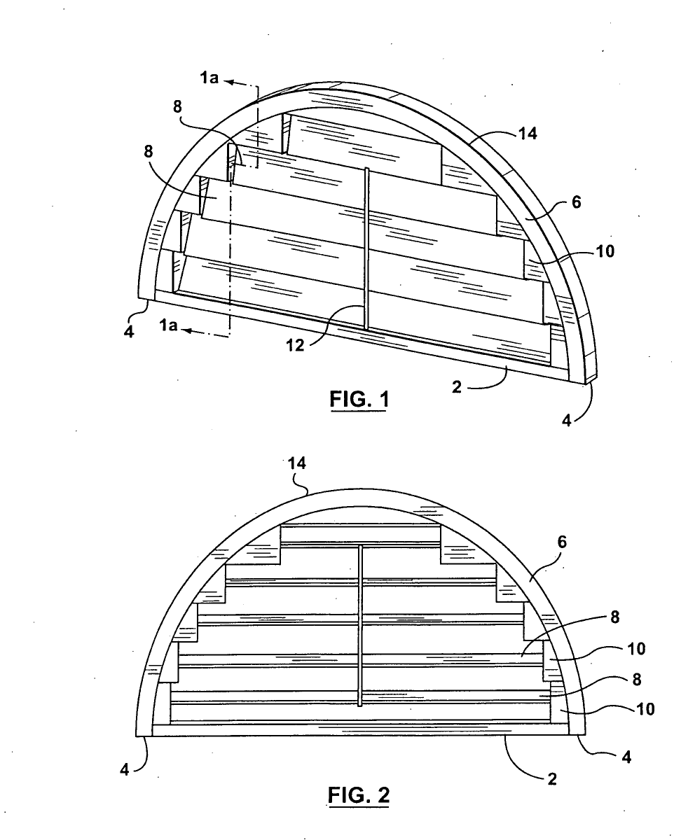

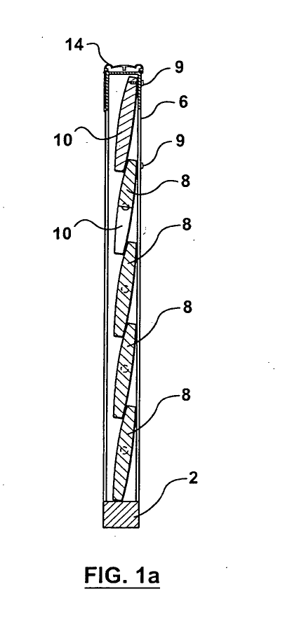

As shown in FIG. 1, the shutter of the present invention comprises a base member or rail 2 connected to the ends 4 of a curved member or rail 6 to form a shape corresponding to the arch of an arched window. The base member in the embodiment shown extends generally linearly to present two opposite ends. One or more adjacent horizontal louvers 8 extend across the width of the arch. In one embodiment, each end of each louver is connected to the curved member by rotating attachment means to louver receiving means 10 fixed to the curved member. Preferably, the rotating attachment means is a pin (not shown) set in to both the louver and the louver receiving means. However, other rotating means such as screws or the like could be used. The louver receiving means are preferably of the same cross section as the louvers. Light control means 12, which may be a pull bar, is attached to each louver. The light control means may be raised or lowered to move the louvers between open and closed positions. Surface tension or friction at the ends of the louvers is sufficient to permit the louvers to remain in the position to which they are moved by adjustment of the light control means (i.e. the friction between the rotating attachment means and the louver receiving means). A valance 14 may be attached to the base member 2 and the curved member 6 to improve the finished appearance of the shutter. In FIG. 1, the louvers are shown in a substantially closed position.

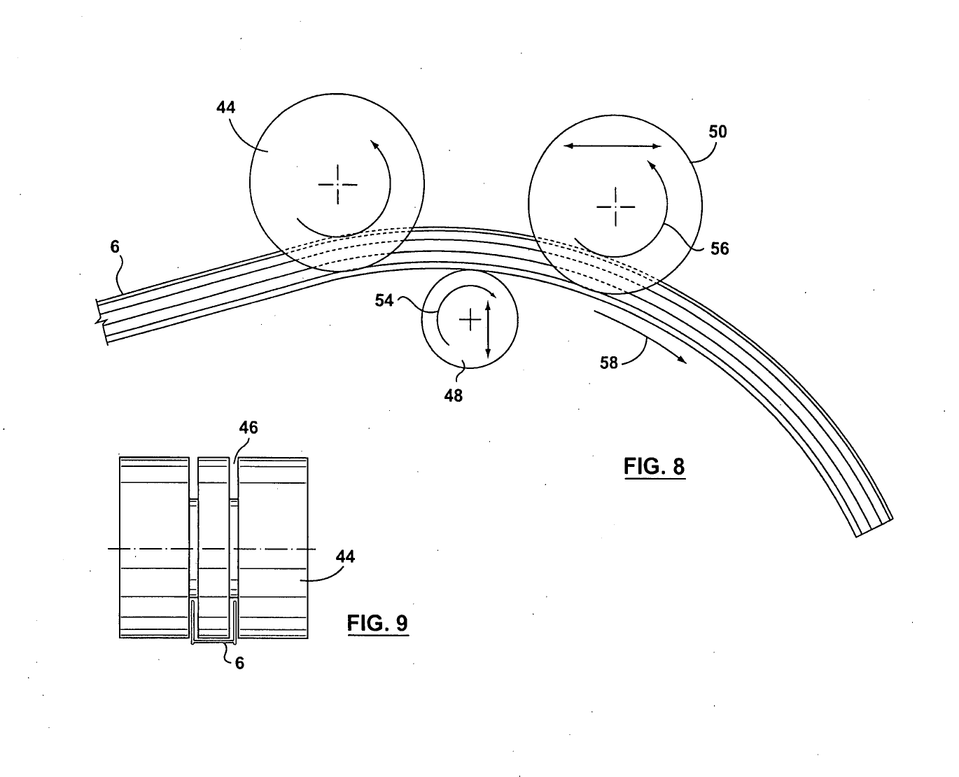

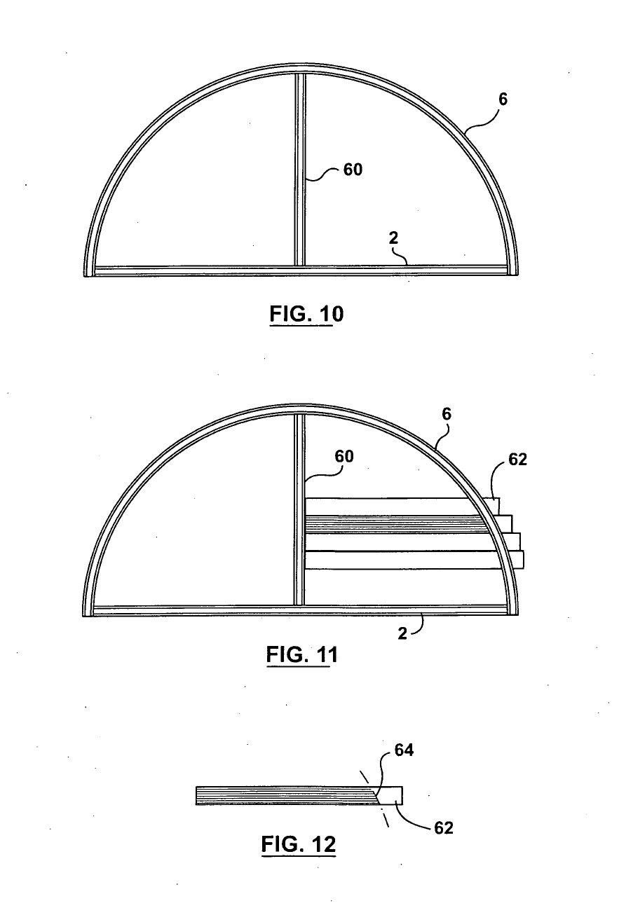

In another embodiment shown in FIG. 10, a stile 60 may extend vertically from the midpoint of the base member 2 to meet the curved member 6. In this embodiment, the outer end of each louver is rotatably connected to louver receiving means attached to the curved member and the inner end of each louver is rotatably attached to the stile. Light control means are attached to each set of louvers on each side of the stile to permit independent adjustment of the louvers on the right and left sides of the shutter. Any number of stiles could be utilized to produce separately operable window sections.

In FIG. 2, the louvers are shown in an open position to permit entry of light through the window.

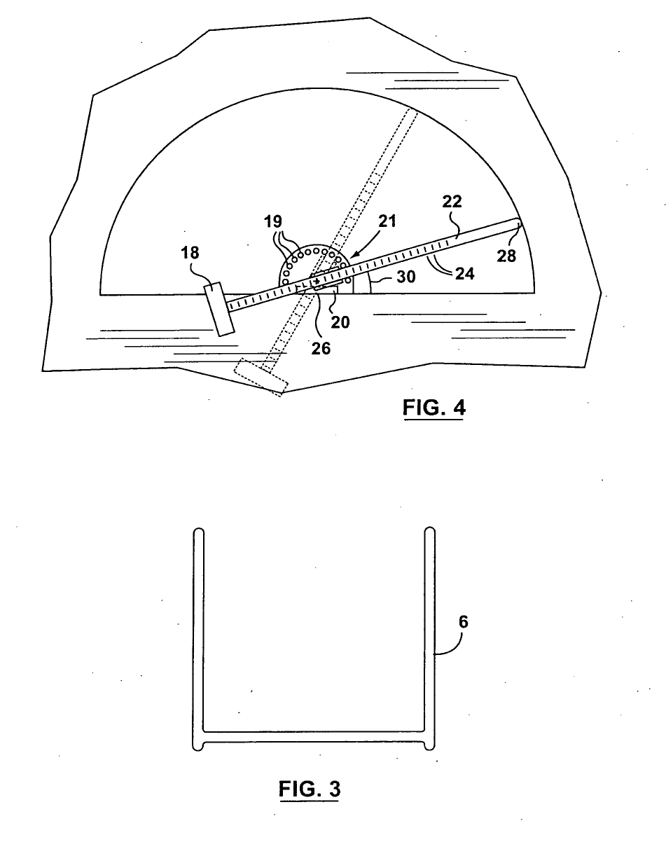

Referring now to FIG. 3, a transverse cross-section of one embodiment the curved member 6 is shown.

The window shutter in one embodiment is designed to be custom fit to an arched window. Alternatively the shutter may be formed to standard sized arches. Once the window shutter is assembled, it is easily inserted into and attached to the frame surrounding the arched window. The louvers may then be adjusted by raising or lowering the light control means to control the amount of light entering the window.

The horizontal arrangement of the louvers allows for consistent light control. As horizontal Venetian-style blinds are in common use, the horizontal arrangement of the louvers of the present invention will provide a uniform appearance with standard rectangular shutters covering the non-arched lower portion of an arched window.

The louvers of the present invention in one embodiment can be rotated as much as 160 degrees, and their rotation can be motorized.

In contrast with many light control means for shutters which comprise long cords potentially harmful to young children, the light control means of the present invention remains safely out of reach of young children for improved safety.

The shutter may be manufactured of wood, aluminum, polyvinylchloride or plastic material or other suitable materials. Louvers may be spring-loaded in engagement with the louver receiving means, permitting easy removal for cleaning and repair.

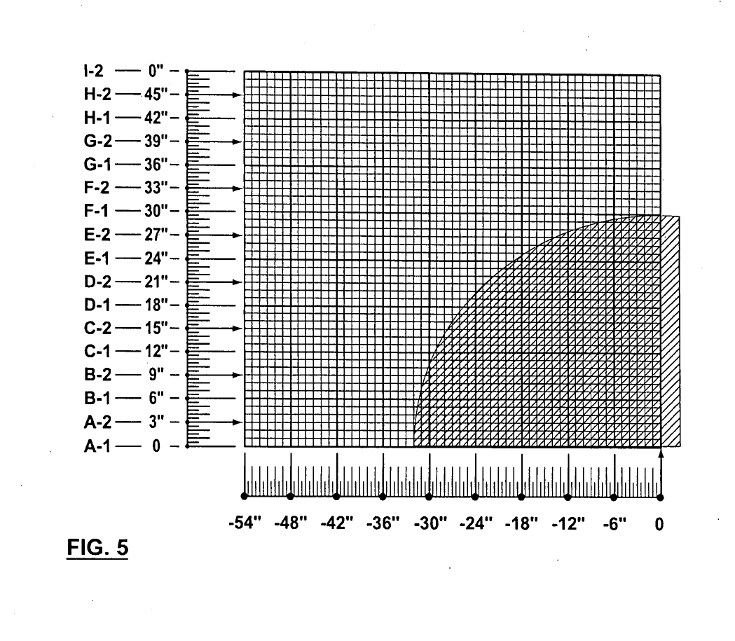

In order to ensure an optimal fit of the window shutter in the arched window frame, the shape of the window opening should be accurately determined. Such determination may be made with the arched window measuring device 18 of the present invention. According to one embodiment of an arched window measuring device, there is provided a leveling mechanism 20 as shown in FIG. 4. The pivoting arm is demarcated in measuring increments 24. The leveling mechanism is positioned at the approximate midpoint 26 of the horizontal surface of the window opening. The distal end 28 of the pivoting arm is positioned in one lower corner of the arched window opening. As the distal end is traced about the perimeter of the arched window, a series of measurements are recorded from the demarcations on the pivoting arm as it slides in and out of the leveling mechanism and the angle 30 of the pivoting arm relative to the base. These measurements may be recorded on a grid as depicted in FIG. 5 or electronic recording media to provide a template for curvature of the curved member of the shutter.

In one embodiment of the invention a series of holes 19 spaced at for example 10 degree increments can be adapted to receive a projection 21 on the underside of arm 22. In one embodiment the projection can comprise a spring loaded ball to engage the holes 19. Once the ball engages one hole 19 it can easily be displaced to the next available hole at a selected angular displacement.

Another measuring means can comprise the grid depicted in FIG. 5. A series of horizontal and vertical coordinates corresponding to a series of points along the perimeter of the window opening are recorded on the grid; and the shutter formed to correspond to the measurements made manually. The shaded area represents the geometry of the left side of the window opening.

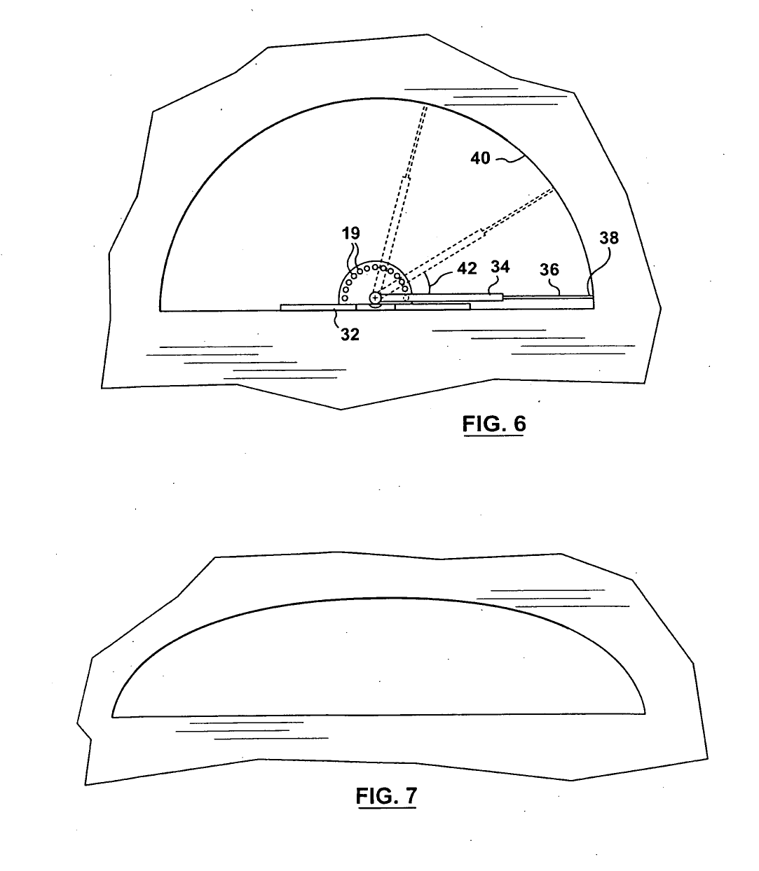

In an alternative embodiment of an arched window measuring device as shown in FIG. 6, there is provided a leveling mechanism 32 attached to a telescopic pivoting arm 34. The telescoping element 36 of the pivoting arm is demarcated in measuring increments (not shown). The leveling mechanism is positioned at the approximate midpoint of the horizontal surface of the window opening. The distal end 38 of the pivoting arm is positioned in one lower corner of the arched window opening. As the distal end is traced about the perimeter of the arched window, a series of measurements are recorded from the demarcations on the telescoping element and the angle 42 of the pivoting arm relative to the base of the window. As in FIG. 4 a plurality of holes 19 are adapted to receive a spring loaded ball. As a further alternative a laser measuring device can be used which is rotated about a pivot point and selectively rotated while digital reading displays as to the length from the pivot point to the respective arch location.

The shutter of the present invention is adaptable to a wide variety of arched window openings, including windows with low arch heights, sometimes referred to as “eye-lid” windows, as shown in FIG. 7, and high arch heights. The radial distance from the midpoint of the base of the window opening to the perimeter may be constant or variable. The window opening need not be horizontally symmetrical.

The curved member of the present invention may be formed by a computerized roll-forming machine having a CNC machine or the like. As shown in FIG. 8, the roll-forming machine comprises a set of rollers which co-operate to effect the desired curvature of the curved member. Three rollers are shown by way of example in FIG. 8. A first roller 44 holds the curved member 6 in a selected position and feeds the curved member between the three rollers. As shown in FIG. 9, the first roller 44 comprises slots 46 about the circumference of the roller for engagement of the sides of the curved member 6.

Referring again to FIG. 8, a second vertically-displaceable roller 48 is positioned downstream of the first roller and adjacent the opposite side of the curved member. A third horizontally-displaceable roller 50 which comprises slots about its circumference for engagement of the curved member is positioned downstream of the second roller. The direction of rotation (52, 54, 56) of the first roller 44, second roller 48 and third roller 50 result in the curved member moving in the feed direction 58.

Window measurement data are entered into the processor of the roll-forming machine to vertically displace the second roller and horizontally displace the third roller to effect the desired curvature to the curved member. The resulting curvature will correspond to the measured geometry of the arched window opening.

In the preferred embodiment, the process of manufacturing the shutter begins with preparation of a template of the geometry of the window opening by obtaining a series of measurements of the horizontal and vertical coordinates along the perimeter of the window opening. Next, an aluminum member is curved according to the template to correspond to the curve of the perimeter of the window opening. The member may be curved using a computerized three-roller roll-forming machine. As shown in FIG. 10, a base member 2 is attached to the curved member 6 to form a closed loop. If one or more stiles 60 are to be added, each is positioned perpendicular to the base member at a desired location.

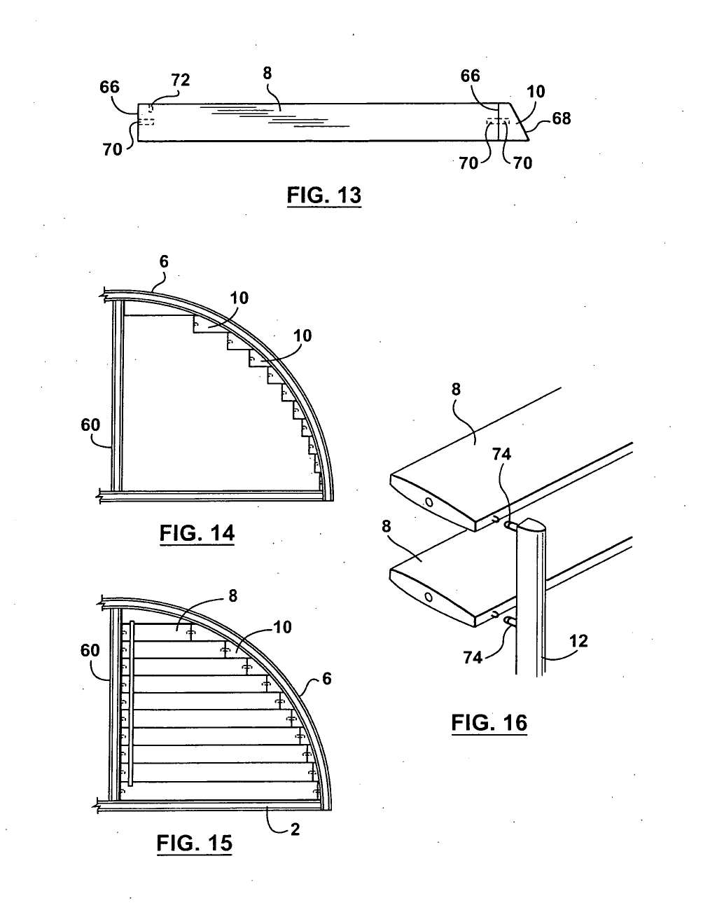

As shown in FIG. 11, one or more source members 62 are rough cut to a length which corresponds to the width of the curved member at the point of installation of the louver to be cut from the source member. The source members are then laid out against the curved member and the curve of the rail at the installation point is traced onto the source member, as depicted in FIG. 12. Each end of the source member is cut on a scroll saw along the trace line 64 to a shape which corresponds to the curve of the curved member at the point of installation of the louver to be cut from the source member. As shown in FIG. 13, straight end edges 66 are cut perpendicular to the length of the source member at positions in proximity to each end to form a central rectangular louver 8 and a louver receiving means 10 at each end of the louver. The straight end edges 66 of the louver and of each receiving means are prepared for finishing and are finished with paint or varnish. Curved edges 68 of the louver receiving means are hidden from view and need not be finished. Finishing may be painting of the straight edge surfaces.

A hole 70 is drilled at adjacent positions in the straight edge of each louver and corresponding louver receiving means for insertion of a louver pin. If one or more stiles are incorporated in the shutter, a series of holes is drilled in the stiles to correspond to the holes in the adjoining louvers. A pull bar hole 72 is drilled in each louver for insertion of a pull-bar pin 74. Other light control means, however, can be used such as staples or other structures to move the louvers.

As shown in FIGS. 1A, 14 and 15, each pair of louver receiving means 10 is attached to the inside of the curved member at horizontally opposed positions by any suitable attachment means such as screw or rivet 9 or the like. The louvers 8 and louver receiving means 10 are shown in FIG. 1A overlap. Alternatively, they may be disposed in side by side fashion so as not to overlap. Each louver is attached to a pair of louver receiving means by insertion of a louver pin into each pair of corresponding holes in the straight edges of the louver and adjacent louver receiving means. As shown in FIG. 16, each louver 8 is attached by a pull-bar pin 74 to a pull-bar 12 or other light control means.

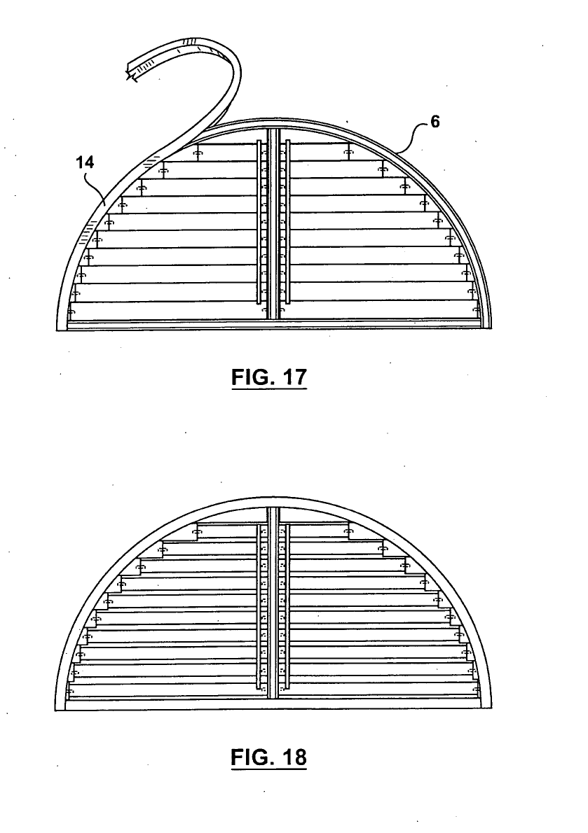

As shown in FIG. 17, a flexible valance 14 is cut to a length corresponding to the combined length of the curved member and the base member and the valance is attached to the exposed face of the curved member and base member to produce the fully assembled shutter shown in FIG. 18.

The one piece aluminum construction of the curved member provides a high degree of structural strength, and the roll-forming machine process allows a precise match between the shape of the shutter and the shape of the arched window opening, as well as increased productivity time.

The relatively simple manufacturing process described above is cost effective and efficient. It eliminates the need for expensive machinery, highly skilled craftspersons, and extensive labour. The shutters can be manufactured in a space as small as 1000 square feet. By way of example each worker should be able to produce 3.5 shutters per day. There is less than 10% scrap produced.

The entire shutter can be manufactured and assembled remote from the installation site.

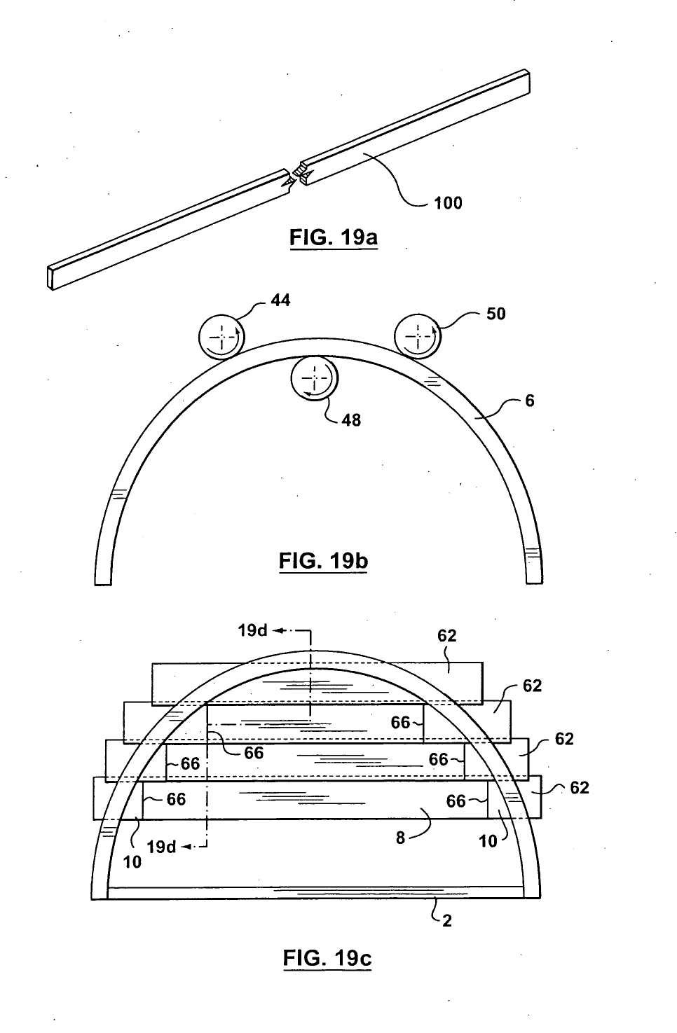

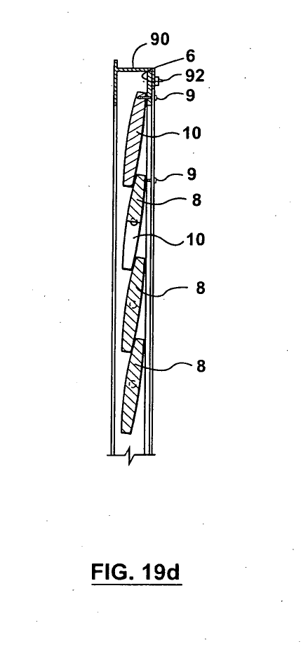

Another embodiment of the invention is shown in FIGS. 19a and 19b which comprises of a substantially flat member 100 which can be curved in a CNC machine by rollers 44, 50, and 48 as previously described to produce a curved member 6 which is substantially flat, or disposed in a plane.

A plurality of overlapping source members 62 can be disposed as shown in FIG. 19c so as to produce a plurality of louvers disposed in generally parallel fashion relative to the base member 2. Each of the source members 62 may be cut as previously described along straight end edges 66 to produce a plurality of louvers and louver receiving means 10 which are joined for rotational movement as previously described.

Furthermore valance 90 having a cross-section shown in FIG. 19d may be secured to the curved member 6 by a suitable number of screws 92 as shown.

Moreover the valance 90 can also be curved to the curvature of the arched window as previously described.

The plurality of louver receiving means 10 may be secured by a plurality of fastening means 9 as shown. In the embodiment shown in FIG. 19d the louvers and louver receiving means 10 overlap one another as shown. Accordingly fastening means such as screws 9 can be used whereby one screw can be adapted to penetrate and fasten through the louver receiving means 10. Alternatively, the louver receiving means 10 and louvers 8 may be disposed in side by side fashion so as to not overlap and accordingly fastening means can be utilized to secure the louver receiving means to the curved member 6. Any suitable number of fastening means can be used.

Furthermore the flat curved member 6 can be used as a template or jig so as to cut the ends of the source members 62 at the same time once connected as shown in FIG. 19d to conform to the curvature of the arch.

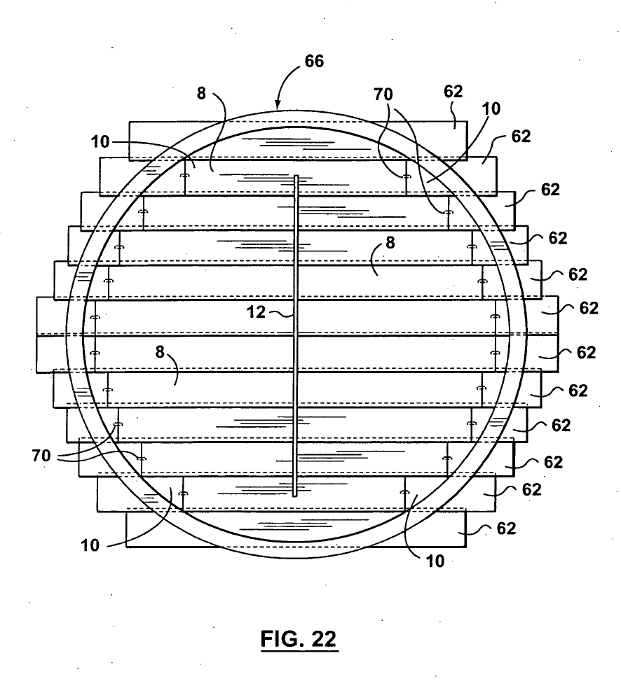

FIG. 22 illustrates another embodiment of the invention where the flat member 100 is curved to define a circle for a circular window. The shutter is constructed similar to that shown in FIGS. 19a, 19b, 19c and 19d. Once the source members 62 are fastened with fastening means 9, the circular edge 67 can be used as a jig or guide to cut the source members 62 off to define the circular shutter.

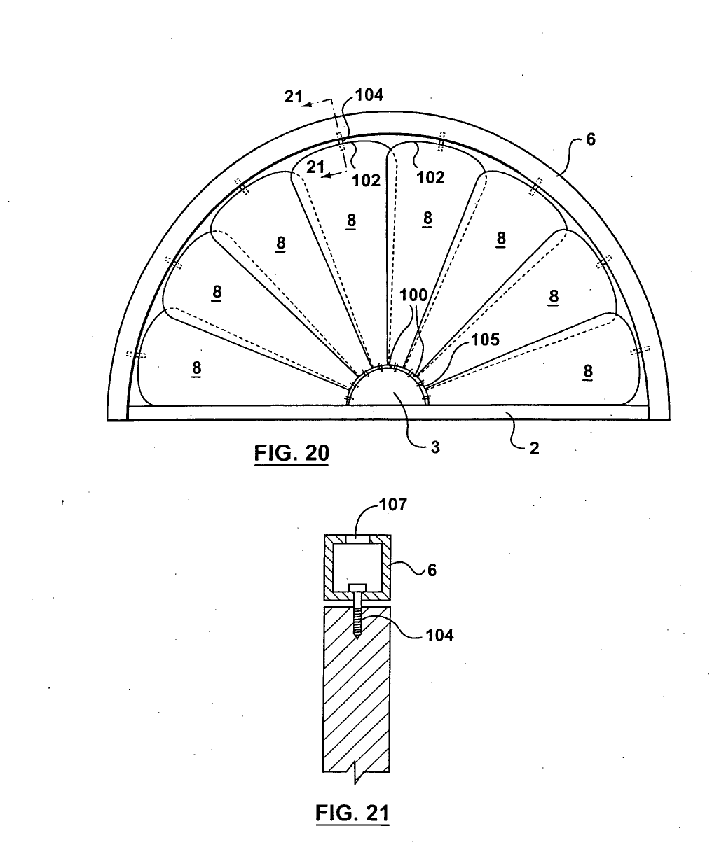

Another embodiment of the invention is shown in FIG. 20 in relation to a palladian blind style window shutter.

In particular the palladian style shutter comprises of a curved member 6 and a base member 2. The base member 2 has a central region 3 which is adapted to contact one end 100 of the louvers 8. The other end 102 of the louvers 8 are adapted to be adjacent the curved member 6.

The curved member 6 may comprise of a channel, hollow tubular, rectangular, or other suitable cross-section which can be adapted to receive securing means 104 for securing the end 102 of the rotatable louvers 8. More particularly the securing means 104 comprise of for example screws, pins, rivets 104 or the like which permit the louvers 8 to rotate about an axis of rotation defined by the securing means 104 and 105 for each louver 8.

The other end 100 of the louver 8 is secured for rotation about securing means 105 which are similar to those of securing means 104. The ends 100 and 102 of the louvers 8 are configured so as to permit rotational movement about the axis defined by pins 104 and 105. The louvers 8 as shown in FIGS. 20 and 21 can be manipulated by manual or other suitable means.

The embodiment shown in FIGS. 20 and 21 permit easy manufacture of a palladian style shutter. In one preferred embodiment the curved member 6 is comprised of aluminum, plastic or even laminated wood having a curved profile as shown as well as a channel, hollowed tubular or rectangular cross-section as shown. The rectangular cross-section shown in FIG. 1 also includes a suitable hole 107 to permit the insertion of the securing means 104 as shown. The louvers 8 can comprise of a variety of materials including wood, plastic or the like.

The curve and base members 2 and 6 are manufactured as previously described. The palladian style louvers 8 are cut to size and the ends 100 and 102 drilled to receive the receiving means 104. The curved section is also drilled to produce the holes 107 which are adapted to receive the securing means 104.

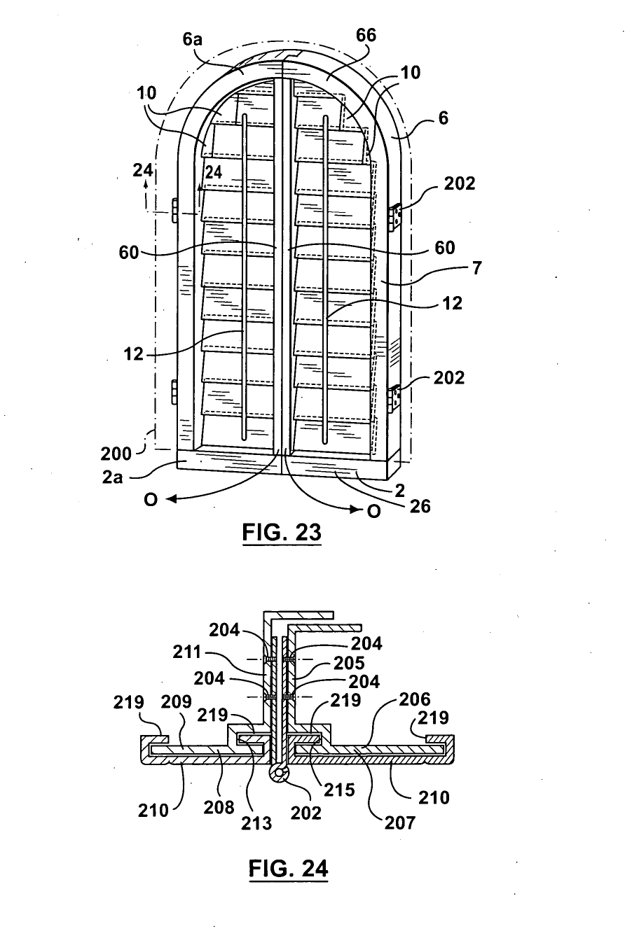

Another embodiment of the invention is illustrated in FIG. 23 which comprise of a shutter for a window where the shutter has a curved member 6 merging with a linear member 7. The shutter also includes a base member 2 which is comprised in two parts 2a, 2b. The curved member 6 is also comprised in two parts, namely 6a, 6b to permit the shutter to swing about hinges 202 in the direction of the arrow O.

The shutters shown in FIG. 23 are adapted to be inserted into a frame 200 as more particularly illustrated in FIG. 24. The frame 200 comprises of a frame extrusion 208 which can be made from a variety of materials including extruded aluminum. The extruded frame 208 includes a front section 209 and a hinge section 211. The front section 209 also defines a recess 213 which is adapted to receive a decorative facing or coping 210. The hinge section 211 is adapted to be connected to the hinge 202 by means of a plurality of screws 204 as illustrated in FIG. 24.

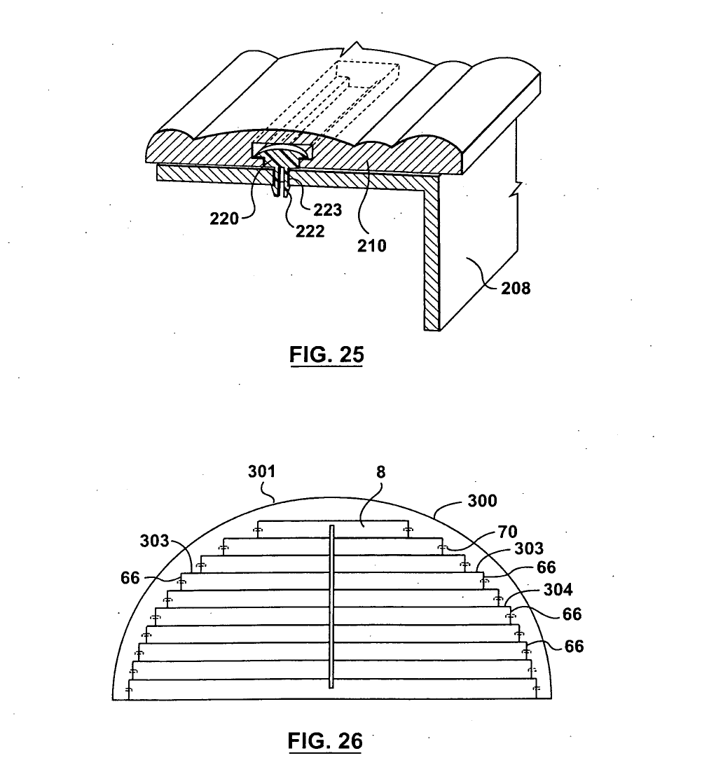

The curved section 6a, 6b and linear section 7 can comprise of an aluminum extrusion having the profile shown in FIG. 24. In particular the cross-sectional profile of curved member 6a, 6b and linear member 7 can comprise of the shutter extrusion 206 as shown. The shutter extrusion 206 includes a front shutter section 207 and hinge shutter section 205. The hinge section 205 is adapted to be secured to the hinge 202 by means of a plurality of screws 204 as shown. Also, the front shutter section 207 includes a recess 215 which are adapted to receive the coping or finished surface 210. The finished surface 210 is also illustrated in FIG. 25. More particularly the finished surface 210 presents an appealing finished surface which follows the contour of the shutter as shown in FIG. 23.

Coping or finishing surface 210 includes compression fingers 219 which are adapted to embrace the front extrusion surface 206 and 209 as shown.

FIG. 25 shows an alternate way of fastening the coping or finishing surface 210 to the extrusion frame 208 by means of a plurality of buttons 220 which are adapted to be received by appropriate recesses 221 located in the coping 210 as shown. The buttons 220 can include a plurality of legs 222 which are adapted to be received and retained within appropriate holes 223 located in the extrusion 208.

FIG. 26 illustrates a further embodiment of the invention whereby at least one pair of spaced louver receiving means 66, 66 are presented by the curved member 300 for releasably attaching the louvers 8 about the axis of rotation. More specifically the curved member 300 includes a first curved edge 301 and a spaced edge presenting a plurality of linear edges 303 and 67. More particularly the edges 303 and 67 define a louver receiving means. A plurality of spaced louver receiving means 10 are presented as shown and are adapted to accommodate louvers 8 for axial rotation as previously described.

It will be appreciated by those skilled in the art that other variations of the preferred embodioment may also be practiced without departing from the scope of the invention. For example the base member case either be horizontally or vertically disposed depending on the direction of the window. Furthermore the base member may also be disposed at an angle to the horizontal.

I claim:

1. A shutter for an arched window having at least one rotatable louver.

2. A shutter for an arched window comprising:
(a) a curved member,
(b) at least one rotatable louver having an axis of rotation,
(c) at least one pair of spaced louver receiving means disposed about said curved member for releasably attaching said louver about said axis of rotation, and
(d) means for rotating said louver about said axis of rotation between an open position and a closed position.

3. A shutter of claim 2 including means for rotating said louvers about said axis of rotation between an open position and a closed position.

4. The shutter of claim 3 further comprising a plurality of louvers each having an axis of rotation, disposed generally parallel to one another.

5. The shutter of claim 4 wherein the louvers and the louver receiving means have substantially the same cross-section.

6. The shutter of claim 5 including a linear member, where said curved member is secured to said linear member.

7. A shutter for an arched window comprising:
(a) a curved member having horizontally opposed ends,
(b) a horizontal member extending between said opposed ends of said curved member,
(c) one or more pairs of louver receiving means for releasably attaching louvers to said curved member, each element of each pair fixedly attached at horizontally opposed positions to said curved member,
(d) one or more louvers having opposed ends and opposed first and second lateral edges, each end of each louver releasably attached by rotating means to a corresponding element of a corresponding pair of louver receiving means, and
(e) light control means for rotating said one or more louvers, attached at vertically adjacent positions to said first lateral edge of each louver, wherein said light control means are vertically displaceable to a selected position between an open position and a closed position.

8. The shutter of claim 7 further comprising at least one stile extending vertically between the horizontal member and the curved member, the stile fixedly attached to an adjacent edge of each louver.

9. The shutter of claim 2, wherein the curved member is selected from the group having a generally U-shaped cross section, flat, hollow tubular, hollow rectangular cross-sections.

10. The shutter of claim 9, further comprising a valance releasably attachable to the curved member.

11. The shutter of claim 7, wherein the curved member is formed of aluminum, wood or PVC.

12. The shutter of claim 6, wherein the rotating means comprises a spring-loaded pin.

13. A shutter for an arched window comprising:
(a) a base member;
(b) a curved member secured to said base member, said curved member having a hollow cross-section;
(c) a plurality of radially overlapping louvers having one end connected to said curved member and said other end connected to said base member, said louver each rotated about a radial axis of rotation.

14. A shutter as claimed in claim 13 wherein said curved member comprises aluminum extended hollow member, and said louvers are comprised of plastic.

15. A method of manufacturing a shutter for an arched window comprising the steps of:
(a) forming a curved member;
(b) attaching a base member to opposite ends of said curved member;
(c) placing a plurality of overlapping louvers on said member;
(d) cutting each said louver to the shape of said arched window, and to form a louver and pair of louver receiving means attached to said curved member;
(e) attaching each said pair of louver receiving means to said curved member.

16. A method as claimed in claim 15 wherein said curved member is flat and is used as a guide for cutting said louver receiving means to correspond to the said shape of arched window.

17. A method as claimed in claim 15 wherein said louvers are placed in overlapping substantially parallel disposition relative said base member.

18. A method as claimed in claim 15 wherein said louvers are placed in overlapping radial disposition relative said member.

19. A method of manufacturing a shutter for an arched window comprising the steps of:
(a) preparing a template of the shape of the blind,
(b) forming a curved member which geometrically corresponds to the template,
(c) attaching a base member to opposed ends of the curved member,
(d) cutting one or more source members to a length which corresponds to the horizontal width of the curved member at the corresponding installation position for each louver,
(e) cutting each end of each source member to geometrically correspond to the curved member at the installation position for each louver,
(f) cutting two straight edges perpendicularly through each source member at positions proximal to each end to form a louver and a pair of corresponding louver receiving means,
(g) preparing and finishing each straight edge of each louver and each pair of louver receiving means,
(h) drilling a hole in each louver for attachment of a light control means pin,
(i) drilling a hole in the straight edge of each louver and a corresponding hole in the straight edge of each louver receiving means for attachment of louver pins therebetween,
(j) fastening each pair of louver receiving means to horizontally opposed positions on the curved member,
(k) fastening each louver to a corresponding pair of louver receiving means and to the light control means,
(l) cutting a flexible valance to a length corresponding to the combined length of the curved member and base member, and
(m) attaching the valance to the exposed surface of the curved m ember and base member.

20. The method of manufacturing the shutter of claim 12, further comprising the steps of:
(a) after attaching the base member to the curved member, attaching one or more vertical stiles between adjacent vertical positions of the base member and the curved member,
(b) drilling a hole in adjacent positions on one lateral edge of each louver for attaching the one or more vertical stiles to each louver and a series of corresponding holes on each stile, and
(c) fastening each louver to the one or more stiles.

21. The method of manufacturing the shutter of claim 19, wherein the step of preparing a template of the shape of the blind comprises the following steps:
(a) measuring and recording on recording media with measuring means the linear distance from the horizontal mid-point of the base of the arched window to one end of the base of the arched window,
(b) measuring and recording on recording media the linear distance from the horizontal mid-point of the base of the arched window to a point along the arc of the arched window and the angle of the radius at that point relative to the base of the window, and
(c) repeating the previous step until the entire arched window has been measured and recorded on recording media.

22. The method of manufacturing a shutter of claim 21, wherein the recording media comprises a markable grid.

23. The method of manufacturing a shutter of claim 20, wherein the recording media comprises an electronic recording medium.

24. The method of manufacturing a shutter of claim 21, wherein the measuring means comprises a measuring device having telescoping arms which selectively transmits the linear distance between the distal ends of the telescoping arms and the angle of the radius relative to the base of the window to an electronic recording medium.

25. The method of manufacturing a shutter of claim 24, wherein the step of forming a curved member which corresponds to the template comprises the following steps:
(a) cutting a length of linear member corresponding in length to the perimeter of the arc of the arched window, and
(b) passing the linear member through roller forming means, the roller forming means comprising three rollers, each adjustable by adjustment means for shaping the member into a curved member corresponding to the template.

26. The method of manufacturing a shutter of claim 24, wherein the adjustment means comprises manual adjustment means.

27. The method of manufacturing a shutter of claim 24, wherein the adjustment means comprises a computerized system interfaced with the template.

28. A measuring device for measuring the arc of an arched window comprising:
(a) a leveling mechanism,
(b) a pivot arm having first and second opposed ends,
(c) a measuring arm swingable at a first end to the first end of the pivot arm,
(d) measuring means for determining the linear distance between the second ends of the arms and the angle of the radius relative to the base of the window, and
(e) recording means for selectively recording the distance between the distal ends of the arms.

29. The shutter of claim 10 further including a finished surface secured to said aluminum curved surface.

30. A finished surface for an aluminum extrusion formed in a curve for receiving rotatable shutters, said finished surface removably secured to said aluminum extrusion.

31. A finished surface as claimed in claim 29 wherein said finished surface includes compressible fingers for capturing said aluminum extrusion.
